(19) United States
(12) Patent Application Publication
(10) Pub. No.: US 2025/0160561 A1
(43) Pub. Date: May 22, 2025

(54) BUBBLE MAKER SYSTEM

(71) Applicant: Sunbeam Products, Inc., Atlanta, GA (US)

(72) Inventors: Enrique Plazarte, Fort Lauderdale, FL (US); Marie Chenowith, Boynton Beach, FL (US)

(21) Appl. No.: 18/840,159

(22) PCT Filed: Feb. 22, 2023
(86) PCT No.: PCT/US23/62976

§ 371 Date: Aug. 21, 2024

Related U.S. Application Data
(60) Provisional application No. 63/312,638, filed on Feb. 22, 2022.

(51) Int. Cl. A47J 31/40; A47J 43/07

(52) U.S. Cl. CPC A47J 31/40; A47J 43/07

(57) ABSTRACT

The present invention is a bubble maker system comprising a bubble dropper and a bubble container. The bubble dropper may be configured to receive and mix a bubble juice mixture and a desired liquid and dispense a. bubble juice. The bubble dropper may include a chamber in which the bubble juice mixture and the desired liquid are introduced, a bath paddle contained within the chamber, a. paddle motor in mechanical communication with the bath paddle such that the paddle motor is configured to drive rotation of the bath paddle, and a plunger configured to dispense the bubble juice after the bath paddle mixes the bubble juice mixture and the desired liquid to form the bubble juice. The bubble container may be configured, to receive the bubble juice which is dispensed from the bubble dropper.

### CROSS-REFERENCE TO RELATED APPLICATIONS

This application claims priority to U.S. Provisional Patent Application Ser. No. 63/312,638, filed on Feb. 22, 2022, entitled “Bubble Maker System,” currently pending, the entire disclosure of which is incorporated herein by reference.

### FIELD OF THE INVENTION

The present invention relates generally to an edible bubble maker system. More particularly, the present invention relates to a system for preparing and dispensing bursting bubbles which may be mixed with a beverage.

### BACKGROUND OF THE INVENTION

Various types of bubbles exist for use in bubble tea beverages. These bubble types include tapioca bubbles, jellies, crystal boba, and bursting bubbles. Bursting bubbles consist of an exterior gel coating filled with a liquid, such as syrup, juice, tea, coffee, etc., that infuses additional flavor into a beverage. Currently, users may purchase pre-made bursting bubbles for subsequent at-home use. However, currently only a limited number of flavors are available, and such bubbles typically contain a high amount of sugar and may have a chemical aftertaste due to the preservatives used to keep the bubbles “shelf stable.”

Users may also make bursting bubbles manually at home. Current solutions involve manually mixing sodium alginate, distilled water, and a desired liquid, such as tea, coffee, juice, syrup, etc., together to form a bubble mixture. This process is slow, as the mixture must rest for approximately thirty to ninety minutes to allow the air bubbles to escape from such mixture. Droplets of the bubble mixture must then be manually dropped into a calcium bath to produce the bursting bubbles. This manual process often results in inconsistent bubble sizes with varying diameters.

As such, a need exists for an at-home bubble maker system that improves on the consistency and efficiency of current bubble making solutions. Additionally, a need exists for a bubble maker system that results in bursting bubbles with improved taste and an easy way to make bubbles with a wide range of flavor alternatives.

### SUMMARY OF THE INVENTION

This invention provides a bubble maker system for preparing bursting bubbles for use in beverages, such as tea, coffee, juice, water, etc. More particularly, a bubble maker system is provided that can be used for personal use (e.g., at home).

The bubble maker system includes a bubble dropper and a bubble container to create the flavored bursting bubbles. The bubble container may receive a bubble making mixture. The bubble maker system may be used to prepare the droplets that will later become bursting bubbles. The bubble dropper may include a stir mechanism and a plunger mechanism. The stir mechanism may include a paddle motor and a bath paddle; the paddle motor may power the bath paddle to mix a bubble juice mixture (which may consist of distilled water, sodium alginate, and a desired liquid, such as tea, coffee, juice, syrup, etc.) within the cup.

The paddle motor preferably powers the bath paddle to mix a bubble juice mixture within the bubble dropper, and the mixed bubble juice may be added into the bubble container. The bursting bubbles can then be formed as a result of the chemical reaction between the sodium alginate within the bubble juice and the calcium chloride within the bubble making mixture, which may already be inside the bubble container. As a result of the chemical reaction, the bursting bubbles may form a hard outer layer, while retaining a portion of the bubble juice in fluid form inside the bursting bubble. The resulting bursting bubbles may subsequently be strained and added to a beverage, such as tea, coffee, juice, water, etc.

### BRIEF DESCRIPTION OF THE DRAWINGS

FIG. 1 is a perspective view of a beverage brewer and bubble maker system; and

FIG. 2 is a cross-sectional perspective view of the beverage brewer and bubble maker system of FIG. 1.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

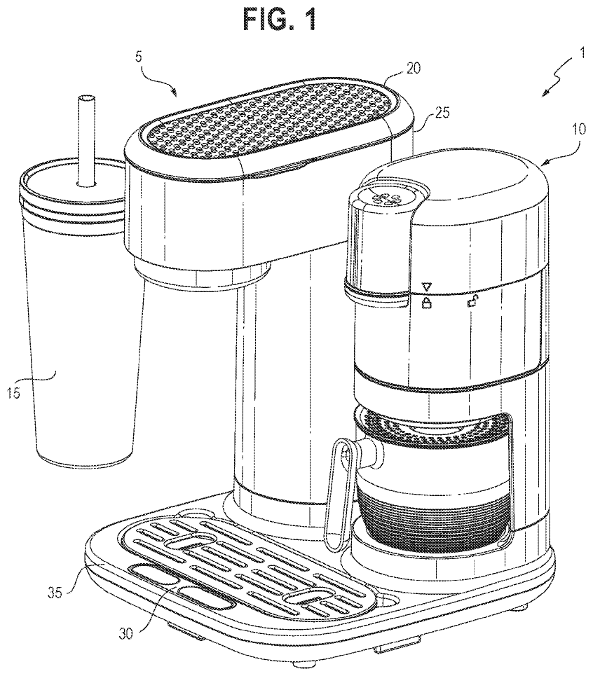

Turning first to FIG. 1, a beverage brewer and bubble maker system 1 is shown, hereinafter referred to as “system” 1. According to one embodiment, the system 1 includes a beverage brewer system 5 and a bubble maker system 10. The beverage brewer system 5 and the bubble maker system 10 may be used in combination with one another, or they may be used independently. The beverage brewer system 5 may be represented by a traditional brewer system for brewing and dispensing a liquid, such as tea, coffee, water, etc., into a tumbler or cup 15. The beverage brewer system 5 may include a brew basket 20. In various embodiments, the brew basket 20 may receive tea bags, loose leaf tea leaves, coffee grounds, tea pods, coffee pods, etc., for use in brewing a beverage. The brew basket 20 may be coupled to a water tank 25, such that heated water in the water tank 25 may be used with the components in the brew basket 20 to brew a beverage.

A user may select a brewing option by using a system controller 30, which may be configured to communicate with the beverage brewer system 5 to brew a certain beverage. The system controller 30 may control the operation of the beverage brewer system 5. Such operations may include brewing a beverage, setting a timer to brew a beverage, and customizing a beverage to be brewed, such as selecting the temperature, strength, and amount of the beverage to be dispensed. When the system controller 30 is activated and a mode is selected, the beverage brewer system 5 may brew a beverage. The beverage may be received within a tumbler or cup 15. The tumbler or cup 15 may rest on base 35 and receive the brewed beverage dispensed from beverage brewer system 5.

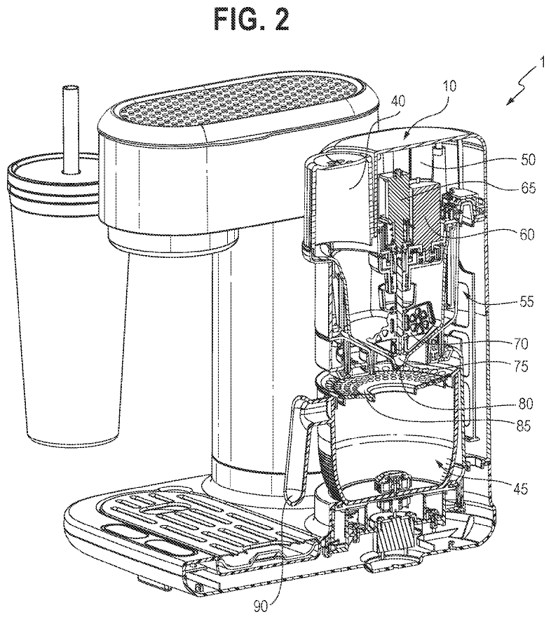

The system controller 30 may also be configured to control the operation of the bubble maker system 10, which is preferably attached to the base 35. Turning to FIG. 2, to prepare the bubble making mixture, a user may fill a preparation container 40 with bubble making ingredients. In various embodiments, the bubble making ingredients are water and calcium chloride powder. In one embodiment, the bubble making mixture may include two cups of water and one tablespoon of calcium chloride powder, though other formulations are envisioned and contemplated herein. The calcium chloride powder may come in the form of a premeasured sachet. Typically, the concentration of calcium chloride in the bubble making mixture will be between 0.5-1%. After the bubble making mixture is prepared, a user may pour it into a bubble container 45, where the bubble juice may subsequently be added. In one embodiment, the bubble container 45 is cylindrical in shape; although in alternative embodiments, the bubble container 45 may be represented by any other suitable shape.

To prepare the bubble juice, a chamber 50 of a bubble dropper 55 may be filled with a bubble juice mixture and a desired liquid, such as juice, tea, coffee, syrup, etc. In one embodiment, the ratio of the bubble juice is ¼ cup of bubble juice mixture and ¼ cup of the desired liquid, though the aforementioned is simply a non-limiting example and other formulations are envisioned. The bubble juice mixture may consist of a premixed amount of distilled water, additives, and sodium alginate. The bubble juice mixture may range in viscosity, for example between 140-400 cP. Typically, a final concentration of alginate in the bubble juice mixture will be approximately 0.5-1%. In certain embodiments, the bubble juice mixture may be premixed in a concentrated or unconcentrated form with an extended shelf life. The bubble juice mixture may come in the form of a multi-serving bottle or a single serving pod. The bubble juice mixture may be used to decrease the preparation time of the bubble juice. Typically, sodium alginate is sold in powdered form and can be difficult to measure. As stated above, the process to prepare the bubble juice mixture directly is slow, as the bubble juice mixture must rest for approximately thirty to ninety minutes to allow the air bubbles to escape from such bubble juice mixture. A premixed bubble juice mixture allows the user to bypass this step of the bubble making process.

Once the bubble juice mixture and desired liquid are added to the chamber 50 of the bubble dropper 55, the system controller 30 may be used to activate a stir mechanism, which may include a paddle motor 60. When the paddle motor 60 is activated, the paddle motor 60 may cause a shaft 65 to rotate. The shaft 65 may be coupled to a bath paddle 70, such that when the shaft 65 rotates, the bath paddle 70 may also rotate in order to prepare the bubble juice. In the current embodiment, the bath paddle 70 may be concentric and may be formed to slide along the edge of the chamber 50 of the bubble dropper 55, although in alternative embodiments, the bath paddle 70 may be represented by any other attachment suitable for stirring and mixing a liquid. According to various embodiments, the bath paddle 70 may contain one or more outwardly extending paddles.

The paddle motor 60 may be used to power the bath paddle 70 to stir the bubble juice mixture and the desired liquid in a circular motion within the bubble dropper 55 to speed up the process for mixing the bubble juice. With the paddle motor 60 activated, the bath paddle 70 may activate to mix the bubble juice mixture and desired liquid to form the bubble juice. The bath paddle 70 may mix the bubble juice mixture and desired liquid without aerating the bubble juice mixture or creating air bubbles. The paddle motor 60 may run for several seconds or more to complete this process. In one embodiment, the paddle motor 60 may run for approximately thirty seconds to complete this process, though in some embodiments run times may be longer or shorter.

After the bubble juice is prepared, the system controller 30 may be used to activate the bubble making process via a plunger mechanism, which may include a plunger 75. In one embodiment, the plunger 75 may be actuated into an open position, allowing the bubble juice to drop downwards towards a chamber exit 80. In one embodiment, the plunger 75 may be actuated into a closed position, pushing the bubble juice out of the chamber exit 80 and into the bubble container 45. Further, when the plunger 75 is actuated into a closed position, the bubble juice may be prevented from sticking to the interior of the chamber exit 80 and allowing the formation of a large drop of bubble juice to fall into the bubble container 45. The plunger 75 may be actuated upwardly and downwardly at predetermined timed intervals for approximately three minutes to create individual droplets that will later form bubbles. The plunger 75 be actuated upwardly and downwardly such that only one droplet drops at a time as the plunger 75 pushes downwardly. The predetermined timed intervals may be used to create droplets that become bubbles that are consistent in size and shape (e.g., approximately 9-12 mm).

When the droplets of the bubble juice fall into the bubble making mixture within the bubble container 45 from the bubble dropper 55, the calcium chloride in the bubble making mixture preferably reacts with the sodium alginate in the bubble juice. This chemical reaction causes the droplets to form a hard outer layer, while retaining a portion of the bubble juice inside the bubble in fluid form. As the droplets fall into the bubble container 45, bursting bubbles may be formed before the droplets of the bubble juice reach the bottom of the bubble container 45. During the bubble making process and when using the specified ratios of bubble making mixture and bubble juice, approximately ¼ cup of bursting bubbles may be prepared, though that number may vary greatly as the recipe changes. The system controller 30 may be used to adjust the speed of the bubble formation, thus allowing the user to vary the size of bubbles.

A strainer 85 may be placed at the top end of the bubble container 45. In one embodiment, the strainer 85 is integrally formed therewith. A handle 90 may be attached to the bubble container 45. The handle 90 may be used to aid in inserting and removing the bubble container 45 from the base 35. The handle 90 may be used to pour the contents out from the bubble container 45. Using the handle 90, a user may pour the remaining bubble juice, along with any mis-formed bubbles, out from the bubble container 45. The user may then pour bursting bubbles (which may remain within the bubble container) into a prepared beverage, such as tea, coffee, juice, water, etc. According to various embodiments, a brewed beverage produced by the beverage brewing system 5, as discussed above, may be combined with the bursting bubbles produced by the bubble maker system 10 to create a bubble beverage.

In an alternative embodiment, the bubble maker system 10 may be used to prepare blended beverages, such as frappes, smoothies, protein shakes, etc. In such an embodiment, a blender-type blade and a blade motor may be located below the bubble container 45. The blender-type blade may be powered by the blade motor. In one embodiment, the blade may be received within a base of the bubble container 45 such that it is capable of stirring and blending contents within the bubble container 45. Desired ingredients may be added to the bubble container 45 and blended together using the blade powered by the blade motor. This alternative embodiment may be used independently or in conjunction with the embodiments described herein. For example, the blended beverage may be combined with bursting bubbles.

In another alternative embodiment, the beverage brewer system 5 may be used to cook tapioca pearls for use in traditional boba tea. The user may place uncooked tapioca pearls in the brew basket 20 of the beverage brewer system 5. A slow flow brewing basket may be used, which may be accomplished by placing a paper filter into the brew basket 20. A tray may be placed within the brew basket 20. The tray may be in the form of a single layer tapioca pearl tray, which prevents the tapioca pearls from sticking together while cooking, and improves the water flow during the cooking process. When the beverage brewer system 5 is run, the hot water flowing through the brew basket 20 preferably “cooks” the tapioca pearls. The user may then remove the cooked tapioca pearls from the brew basket 20 and add the pearls to a prepared beverage.

According to one embodiment, a bubble maker system may include a transparent container to allow a user to view the bubble making process. The size of the bubble maker system may also be smaller overall in comparison to bubble maker system 10 described above.

In various embodiments, the bubble juice mixture and the desired liquid may be added to the bubble dropper 55 via a funnel.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A bubble maker system, the bubble maker system comprising:
a bubble dropper configured to receive and mix a bubble juice mixture and a desired liquid and dispense a bubble juice, the bubble dropper comprising:
a chamber in which the bubble juice mixture and the desired liquid are introduced;
a bath paddle contained within the chamber;
a paddle motor in mechanical communication with the bath paddle such that the paddle motor is configured to drive rotation of the bath paddle; and
a plunger configured to dispense the bubble juice after the bath paddle mixes the bubble juice mixture and the desired liquid to form the bubble juice; and
a bubble container configured to receive the bubble juice which is dispensed from the bubble dropper.

2. The bubble maker system of claim 1, wherein the bath paddle is concentric.

3. The bubble maker system of claim 1, wherein the bath paddle is configured to slide along an edge of the chamber.

4. The bubble maker system of claim 1, wherein when the plunger is in a first position, the plunger prevents the bubble juice from being dispensed into the bubble container.

5. The bubble maker system of claim 1, wherein when the plunger is in a second position, the plunger is actuated away from an opening in the bubble dropper such that the bubble juice is dispensed from the bubble dropper into the bubble container.

6. The bubble maker system of claim 1, further comprising a system controller configured to activate a plurality of modes of the bubble maker system.

7. The bubble maker system of claim 1, further comprising a shaft that at least one of drives rotation of the bath paddle and activates the plunger.

8. The bubble maker system of claim 1, wherein the bubble juice mixture includes sodium alginate with a viscosity between 140 and 400 cP.

9. The bubble maker system of claim 1, wherein the bubble container receives a bubble making mixture.

10. The bubble maker system of claim 9, wherein the bubble making mixture is a mixture of water and calcium chloride powder.

11. A bubble dropper configured to receive and mix a bubble juice mixture and a desired liquid and dispense a bubble juice, the bubble dropper comprising:
a bath paddle configured to stir the bubble juice mixture and the desired liquid into the bubble juice; and
a plunger configured to dispense the bubble juice into a bubble container;
wherein when the plunger is in a first position, the plunger prevents the bubble juice from being dispensed into the bubble container; and
wherein when the plunger is in a second position, the plunger is actuated away from an opening in the bubble dropper such that the bubble juice is dispensed from the bubble dropper into the bubble container.

12. The bubble dropper of claim 11, wherein the bubble container comprises a handle and a strainer.

13. The bubble dropper of claim 11, wherein the bubble container is configured to receive a bubble making mixture.

14. The bubble dropper of claim 13, wherein the bubble making mixture is a mixture of water and calcium chloride powder.

15. The bubble dropper of claim 13, wherein the bubble making mixture is about two cups of water and about one tablespoon of calcium chloride powder.

16. The bubble dropper of claim 14, wherein a concentration of the calcium chloride powder is preferably between 0.5% and 1%.

17. The bubble dropper of claim 11, wherein the bubble juice mixture includes sodium alginate with a viscosity between 140 and 400 cP.

18. The bubble dropper of claim 11, further comprising a shaft that at least one of drives rotation of the bath paddle and activates the plunger.

19. The bubble dropper of claim 18, wherein the bubble container is configured to separate the plurality of bursting bubbles from the bubble juice via a strainer.

20. The bubble dropper of claim 11, wherein the desired liquid is at least one of tea, coffee, juice, or syrup.
